(19) United States
(12) Patent Application Publication
(10) Pub. No.: US 2014/0282780 A1
(43) Pub. Date: Sep. 18, 2014

(54) ENHANCED BROADCAST TELEVISION FOR PORTABLE DEVICES

(71) Applicant: MOTIVE TELEVISION PLC, London (GB)

(72) Inventor: Glenn Ritchie Gordon CRAIB, Dunfermline (GB)

(73) Assignee: MOTIVE TELEVISION PLC, London (GB)

(21) Appl. No.: 13/838,569

(22) Filed: Mar. 15, 2013

(51) Int. Cl. H04N 21/41; H04N 21/262; H04N 21/258; H04N 21/254

(52) U.S. Cl. CPC H04N 21/4126; H04N 21/2541; H04N 21/26283; H04N 21/25841
USPC 725/110; 725/25; 725/54

(57) ABSTRACT

An enhanced manner of providing broadcast television to portable devices is disclosed, including tuner assistance, improvements in recording and datacasting content, and assisting users in obtaining the optimum experience from their set-up. A small form factor, low cost accessory product such as a WiFi dongle with one or more tuners can be used to provide the single function of delivering content to portable devices. The content can be sourced from broadcast (e.g. ATSC/DVB-T, etc.) and can be in the form of live (linear) television or datacast (on demand) programming. No Internet connection is required.

### FIELD OF THE DISCLOSURE

This relates to the provision of content to portable devices, including broadcast television (TV).

### BACKGROUND

Television and radio broadcasts were established to be a one-to-many solution, giving all access to the same piece of content at the same time. There were some restrictions on this, such as location of the receiver and the transmitter, and also social constraints when the receivers were expensive luxury items. Today TV and radio access and reception are taken for granted.

Broadcasting of TV in particular has come a long way in a relatively short time. From initial broadcasts of a limited number of channels “over the air” to hundreds of channels available over cable, satellite and IP transport.

A recent driver of change was the adoption of High Definition (HD) broadcasts, which resulted in the need to adopt digital transmission instead of the traditional analog methods. The transition to digital has happened via government mandate (over the air), the desire to make best use of their spectrum (satellite) and in some cases a desire to keep up (some cable operators). Digital broadcasting has brought a number of advantages to the end customer, a larger number of channels to choose from, and accompanying this a large number of HD channels.

As the number of channels has increased, the viewing figures of the traditional network broadcasters have fallen off, but these major networks are still dominant within the market place. The most popular programs on television are almost all primetime broadcast shows. For niche audiences the provision of “long tail” content has meant that there is a channel for almost everyone within the cable and satellite environments.

In recent years there has been a perception within the marketplace that in order to get the most popular content in HD, a cable or Satellite pay TV subscription was required, as opposed to the old days of using a “rabbit ears” over-the-air antenna. This perception is altering a little, but is still a widely held belief. Pay TV operators have done an excellent job in increasing their ARPU (Average Revenue Per User) over the years, through additional services, and channel bundles. More recently, this ARPU has come under increasing pressure as users look to reduce their household bills. This has lead to two terms being adopted—“cord cutting” and “cord shaving.” It was expected that Pay-TV operators would see a decline in their user base, as contracts were canceled (cord cutting), but instead it appears that users are selecting which services from the operators they wish to keep and canceling some of the others (cord shaving).

Changes in viewing habits have been further driven by the adoption of the Internet to deliver additional content. In most cases, this content has already been broadcast using traditional networks and is offered in a number of ways. This content can be received as free catch up services within a limited time window (such as BBC iPlayer), as part of a subscription package (e.g., Netflix) or as a one-off purchase (e.g., iTunes). One key point in these services is that they require the user to have not only an Internet connection, but a connection with suitable speeds for the download or streaming of the video content. This requirement for Internet access has left a number of people in a new class, known as “data poor.” This class may exist because they cannot afford higher speed connections, or may live in a location that cannot support high-speed data. Another major issue with the delivery of content across the Internet is the amount of data that a high quality download will consume. Many Internet connections have data limits applied, typically monthly. Even many data connections which today are sold as “unlimited” have small print indicating some limits on the service. This is even more apparent when considering mobile networks. Consuming content on a mobile device over 3G/4G can quickly become an expensive proposition, assuming that one can obtain a sustained high bandwidth connection.

### SUMMARY

An enhanced manner of providing broadcast television to portable devices is disclosed. Embodiments include tuner assistance, improvements in recording and datacasting content, and assisting users in obtaining the optimum experience from their set-up.

In one embodiment, a small form factor, low cost accessory product such as a WiFi dongle with one or more tuners can be used to provide the single function of delivering content to portable devices. The content can be sourced from broadcast (e.g. ATSC/DVB-T, etc.) and can be in the form of live (linear) television or datacast (on demand) programming. No Internet connection is required.

In contrast to datacasting content to Set-Top Boxes (“STBs”), which by their nature have abundant storage providing significant advantages for the reception and playback of datacast content/files, the embodiments disclosed herein compensate for the lack of abundant storage in the accessory product and portable devices by datacasting at faster than real time, increasing download speeds, as well as transmitting a number of copies of the same content over a period of time to add redundancy. Multiple content can be datacast at the same time, where this content can be different events or the same event time shifted.

Additionally, electronic programming guide (“EPG”) data can be datacast, both as stand-alone information and also within the main datacast information. Multiple copies of the same event can also be datacast, with each targeted at different portable devices.

Thus, the datacast content can take a number of forms, in order to provide the user with an improved service, and also to provide extended services which offer value to the user and revenue to the operator.

### BRIEF DESCRIPTION OF THE DRAWINGS

FIG. 1 illustrates an example of enhanced broadcast television for a portable device.

FIG. 2 illustrates an example of an accessory to the portable device.

FIG. 3 illustrates an example of a network architecture for the enhanced broadcast television.

FIG. 4 illustrates another example of a network architecture for the enhanced broadcast television.

FIG. 5 illustrates an example of a tuning process for the enhanced broadcast television.

FIG. 6 illustrates an example of a user interface associated with the tuning process.

FIG. 7 illustrates an example of a recording process for the enhanced broadcast television.

FIGS. 8-14 illustrate examples of bandwidth use for the enhanced broadcast television.

FIG. 15 illustrates an example of a computing device.

### DETAILED DESCRIPTION

The present disclosure is directed to an enhanced manner of providing broadcast television to portable devices. Although the embodiments disclosed herein describe provisioning of content to portable devices (e.g., electronic devices intended to be carried around by a user, such as a smart phone or tablet), the disclosure is not so limited and can be used to provide content to an electronic device of any suitable type, such as desktop computers, in accordance with the teachings of the present disclosure.

As described above, viewing figures for the major networks in general have fallen. Despite this, however, there is still a strong demand for certain content, so called “mass market” content. This is true when discussing TV viewing, catch-up or video-on-demand (VoD) content.

A more recent change to content consumption has been driven by the success of smartphones (such as the IPHONE and various ANDROID handsets) and also tablets (e.g. the IPAD). One of the results of the mass market adoption of these devices is that they are both being used when viewers are “watching” TV and also being used to consume content. When watching TV, a growing number of people are using these portable devices to surf the Internet, or to use social networking websites, often to comment on the TV show that is on in the room.

Consuming content on portable devices such as smartphones and IPADs is not as straightforward as using a TV set today. In the majority of cases, any content viewed on these devices has to be sourced over the Internet. This can produce a poor quality of service due to the fact that streaming content across the Internet at a high bit rate is difficult to sustain for the mass market. This also leads to a “digital divide” with again the data poor being sidelined.

Current technology allows users to “placeshift” content from a Set-top box (using products such as SLINGBOX) providing access to live and recorded content on a range of portable devices. However, current products do not allow the user to record content, and allow no direct access to catch-up or VoD content, with again reliance on a suitable Internet connection needed for such services.

One of the major concerns in utilizing broadcast television in a portable environment is the availability of a suitable broadcast signal. Since broadcast is a one to many solution, the receivers have to be within a given range of the transmitter in order to be able to receive it. Further, the physical environment surrounding the receiver can have a dramatic effect on the signal, for example the signal received within an elevator would be significantly lower than the signal that could be received once you step outside the elevator.

In some markets the government or federal agencies have provided websites which give an indication of the expected TV reception at a given location. These websites can also give directional information indicating where a roof mounted antenna should be pointed towards.

Digital broadcasting in the USA is based around the ATSC standard, and as such each license owner has the rights to broadcast up to 19.6 Mb/s of digital content on a given frequency (spectrum). This bandwidth can be used in a variety of ways, with the license holder choosing to broadcast a single channel, multiple channels, etc. Examples of the bit rates associated with different broadcasts are given below:
standard definition (“SD”) content—2-4 Mb/s
high definition (“HD”) content—max 14 Mb/s (typical <12 Mb/s)

From the above, it can be seen that in the majority of cases, the license holder will not be using their full bandwidth allocation. This additional bandwidth can be used for additional delivery of content to portable devices, using existing technology such as provided by MOTIVE TELEVISION PLC.

In addition, as has been proven commercially in Europe, technology such as MOTIVE's TELEVISION ANYTIME ANYWHERE technology has the ability to datacast content in the “white spaces” around programs during channel broadcasts, whether they are SD or HD. Datacasting refers to the use of broadcast television technology to transfer data, typically in the form of a file which can be used at a later date.

The bit rate requirements for content on portable devices are significantly less, being typically 1 Mb/s for current generation tablet devices for example. Therefore, it is possible to deliver content to portable devices in as little as 1 Mb/s, although if additional bandwidth is available a number of possible use cases emerge. Content at 2 Mb/s is viewed as HD on tablets and is of excellent quality.

The present disclosure not only allows for recording/viewing of the additional value datacast content, but also the traditional ATSC broadcast content provided by the broadcaster. Thereafter the user can watch/record broadcast TV as they wish.

Additionally, the present disclosure also supports the use of autorecording. This technology allows broadcasters to instruct the portable device to record certain content. The recorded content then appears to the user on their portable device and can be positioned as stand-alone recorded items, or as a virtual channel, depending on the type/amount of content recorded.

FIG. 1 illustrates an example of enhanced broadcast television for a portable device. In the illustrated embodiment, accessory 100 can comprise a device, such as a WiFi dongle, configured to receive broadcast TV signals and transfer content from those signals to portable device 110. FIG. 2 illustrates an example of accessory 100.

In particular, accessory 100 can comprise processor 200, storage 210, tuner 220, network interface 230, antenna interface 240, antenna 250, power interface 260 and battery 270. Accessory 100 can comprise any suitable shape or size, preferably a small size such as the size of a smart phone or smaller.

Processor 200 can comprise any suitable processor capable of receiving and transferring broadcast TV signals. In one embodiment, processor 200 can include a system on chip (“SoC”) capable of multistream transcoding and advanced media processing, such as a SoC from the XCODE 5100 family manufactured by VIXS. Due to storage limitations, the transcoder can compress the broadcast TV content to a more suitable level, such as 2 live HD broadcasts to H.264 at around 2 Mb/s. Processor 200 can also be capable of receiving/reconstructing datacast content, such as from standard MPEG-TS using existing technology (e.g., using the MOTIVE SDK).

Storage 210 can comprise any suitable storage that allows accessory 100 to recode live ATSC TV (i.e., in transferring broadcast TV content to portable device 110 when available such as via buffering) and to store datacast and/or broadcast TV content flagged for recordation if accessory 100 is not available at the time of the datacast/TV broadcast. In one embodiment, the storage 210 can comprise a minimum amount of storage based on a predetermined amount of recording time, such as 4 GB of built-in memory allowing for 2 hours of recording at 2 Mb/s.

Accessory 100 can also include a peripheral interface (not shown) such as a USB connection to support additional storage capacity. Any connected storage can be tested for speed to ensure recording can take place. However, if the content is protected by digital rights management (“DRM”), then accessory 100 can follow the rules associated therewith which may include blocking from storage on external memory, etc.

Tuner 220 can comprise one or more tuners configured to receive broadcast television signals. In one embodiment tuner 220 can comprise a dual channel tuner to allow recording of one channel and watching a second live, or to allow two portable devices to connect to single accessory 100. In other embodiments, tuner 220 can comprise more than two tuners, though the additional tuners compete against cost and size constraints of accessory 100.

Network interface 230 can comprise any suitable networking capability to allow accessory 100 to communicate with portable device 110. In one embodiment, network interface 230 can include WiFi (a/b/g/n) capability such that accessory 100 can use an existing WiFi network (which can require a simple set up) or generate its own hot-spot for portable device 110 to connect to (e.g., for portable use). Network interface 230 can include an internal antenna, such as a printed circuit board (“PCB”) mounted antenna.

Antenna interface 240 can comprise an interface through which an external antenna, such as an external ATSC home antenna, and/or a built-in antenna, can be connected to accessory 100. Antenna 250 can comprise a built-in extendable (e.g., telescopic) antenna that can be fully retracted into the body of accessory 100.

Power interface 260 can comprise any suitable interface through which accessory 100 can be charged and/or powered by mains, such as via a connectable power adaptor. Battery 270 can comprise any suitable internal power source capable of powering accessory 100, such as for a predetermined amount of time (e.g., 4 hours).

Accessory 100 can also comprise further features (not shown), such as buttons, an indicator, a serial number and certifications. In one embodiment, the buttons can comprise power and reset buttons, such as one button for power on/off and one for reset, which can be hidden where possible. The indicator can indicate battery power, accessory availability and connection status, such as via a tri-color LED (e.g. red indicating battery low, amber indicating accessory 100 available, flashing amber indicating WiFi connecting and green indicating connected to portable device 110). The serial number can comprise a unique serial number which is pre-programmed and also listed on the product label, and the certifications can comprise all relevant certifications that are required to allow sale of accessory 100 in the relevant jurisdiction. Accessory 100 can lack a screen in view of size and power contraints.

Accessory 100 can also maintain a list of authorized connected portable devices (e.g., up to a maximum number such as 3). The first portable device to connect to accessory 100 can be considered the primary device with administrator rights to change settings. Further connecting devices can have lower privileges and require the entry of the accessory serial number to change any settings.

FIG. 3 illustrates an example of a network architecture for a portable use of accessory 100, and FIG. 4 illustrates an example of a network architecture for a home use of accessory 100.

In the portable use embodiment of FIG. 3, broadcast TV signals (e.g., ATSC signals) are transmitted via broadcast cloud 310 (i.e., over the air) from broadcast network 300. Accessory 100 receives the broadcast TV signals via its built-in antenna 250, and transfers content from the received broadcast TV signals to portable devices 110 and 112 via a network (e.g., WiFi hotspot) generated by accessory 100.

In the home use embodiment of FIG. 4, broadcast TV signals (e.g., ATSC signals) are similarly transmitted via broadcast cloud 310 (i.e., over the air) from broadcast network 300. However, in this embodiment external antenna 410 of home 400 captures the broadcast TV signals and provides them to accessory 100 via its antenna interface 240, through which a wire from external antenna 410 is connected. Accessory 100 also transfers content from the received broadcast TV signals to portable devices 110 and 112 via home network 420, to which accessory 100 and portable devices 110 and 112 are both connected.

The connection between accessory 100 and portable devices 110 and/or 112 is not limited to wireless network connections, and in other embodiments can include wired network connections and/or wired direct peripheral connections, such as via USB.

Regarding an example use case for a first time installation of accessory 100, in one embodiment a user can purchase accessory 100 (also referred to as a “T-Pod” hereinafter) and download an app from a relevant app store onto the user's portable device. The user can switch on the T-Pod, and connect to the WiFi hotspot from the T-Pod (called “TabletTV” in one embodiment). The user can then start their app.

When the app starts, it can search for T-Pods on the current WiFi connection. If no T-Pods can be found, the app can check the WiFi connection name (which can be OS dependent) and suggest that the user connect to TabletTV if this is not the current WiFi. Otherwise, the app can provide the user with a message asking the user to ensure that the T-Pod is turned on and within range, and that the WiFi connection for TabletTV is being used.

Once the app and the T-Pod connect using a protocol such as UPnP discovery to exchange IP addresses, the app and T-Pod can exchange their unique serial numbers and create a unique token to be used for communication authentication between them. All communication between the T-Pod and the portable device can be secure such as via HTTPS, with the token being exchanged for further security.

Once the app and T-Pod are connected, the user can be presented with a list of available WiFi networks within the user's location and asked if the user wants to use one of these. If the user selects an existing WiFi network, the user can be asked to enter any security key for that network, and the T-Pod can switch to using that network. The user can be prompted to switch the WiFi on the user's device to whatever WiFi network the user selected. If no WiFi networks are detected, this step can be skipped.

Once the app and T-Pod connect again, the user can be shown a message indicating that this WiFi network can be used automatically if the T-Pod detects it. The user can be provided with an option to cancel this.

Regarding tuner assistance and assisting users in obtaining the optimum experience from their set-up, FIG. 5 illustrates an example of a tuning process for accessory 100 and FIG. 6 illustrates an example of a user interface associated with the tuning process.

One of the issues with using broadcast technology is ensuring the receiving device can receive the signal with the required strength. It is a common feeling in the US that broadcast TV is not for everyone, because they cannot get a decent strong signal. This position is further emphasized by the cable and satellite operators, as would be expected.

Since the recent analog signal switch off, more support has been provided to customers to show them what stations should be received in their location. Government bodies have created websites into which the customer can enter their location, and a list of the available stations, along with their direction and signal strength is provided. This information is provided as an “ideal” case for a TV aerial which is located above the location provided.

STB's for ATSC reception do not use this location information, and simply scan the range of frequencies to locate the channels which are available. This is a time consuming process and as such does not fit with a portable product, which may be moved to different locations many times. Current STB's are designed to be tuned once during installation, then never tuned again.

The present disclosure uses the available signal information, along with location information from the portable device to provide an enhanced customer experience.

In the embodiment illustrated in FIG. 5, to assist with tuning the app can attempt to determine location information for the portable device (block 500) in any suitable manner. For example, in an iOS embodiment the user can be asked to enable location services for this app. If the user declines, the user can be asked for the current zip code. The user can decline this as well, and enter the current location at any time as a zip code for example in a “settings” page. In other embodiments, to obtain location information the app can query an internal Global Positioning System (GPS) chip if the portable device is GPS capable and/or utilize cell phone tower triangulation.

If the location can be determined (e.g., from location services or the zip code), the app can connect to a website to obtain a list of ATSC broadcast stations which should be available at that location (block 510), as well as an indication of signal strength. The app can then tune to the listed stations (block 520). For example, the app can instruct the T-Pod to tune to a mid-range signal strength station, and then receive the current signal strength from the T-Pod.

If the signal strength is deemed to be “acceptable” (block 530), the app can then instruct the T-Pod to check the signal strength of each of the stations available at that location. The difference between the expected signal quality supplied by the website and the received signal quality can be used to determine which stations should be received at that location. Since only a handful of frequencies are tuned, this is a much quicker experience than conventional tuning. The user can then be presented with a list of stations available (block 540).

If the signal strength is not “acceptable” then the app can provide the user with a visual indication of the signal strength (block 550), and ask the user to move/extend the T-Pod's antenna until a suitable signal strength is shown. The user can have the ability to use this signal meter at any time, e.g., through a “settings” page.

Should the location information not be provided, or no suitable Internet connection is available to the portable device, then a scan of ATSC frequencies can be carried out (block 560). At the conclusion of this scan, provided some stations have been found, the signal strength locator can be used to optimize the reception.

In the embodiment illustrated in FIG. 5, a list is shown on the screen of the portable device during the setup for the available channels, along with a check mark/tick (representing strong signal strength), cross (representing weak signal strength) or question mark (representing questionable signal strength) depending on the signal strength. The channel list provided to the user thus has the added feature that lower quality stations are highlighted as being less suitable for recording. Additionally, the signal strength per channel can also be displayed as a “fuel gauge” (e.g., linear) so that the user can see the effect on moving the antenna on the signal quality.

In general on the TV viewing pages, the fuel gauge, or tick, or some other positive indicator can also be shown where possible for the channel the user is currently watching. This indicator can provide live feedback on the quality of the signal and assist the user in moving the antenna to optimize the signal strength.

Also an additional indicator is the battery state remaining of the T-Pod. As shown in FIG. 5, if the T-Pod is operating under battery power, an approximate lifetime or percentage life remaining can be shown.

Regarding an example use case for second and subsequent uses of accessory 100, in one embodiment when the T-Pod is turned on for a second or subsequent time, it can search for available WiFi networks and check which networks it should automatically join. If none are found, then it can use its own WiFi hotspot (e.g., TabletTV) and when the app connects, the app can ask the user if they want to connect to an existing network.

When the T-Pod and app are connected after the first time, the initial assumption can be that the device has not been moved since the last use. If it is not possible to tune to any of the stations which were detected before, then the app can attempt to use location information to find if it has moved. If it has moved, or if location information has not been received, then the user can be asked if the user wants to re-tune at this new location. The same tuning process as for the initial installation can be followed.

Regarding improvements in recording content, FIG. 7 illustrates an example of a recording process for accessory 100.

Currently content being delivered to portable devices is supplied either in the form of streaming or via file download. Current solutions do not record live broadcasts/datacasts directly onto portable devices, instead relying on the transfer of completed files, typically from an Internet source.

The present disclosure allows the user to record directly onto the user's portable device, with additional back-up and feature enhancements.

In the embodiment illustrated in FIG. 7, the user can select to record current live TV events, or future programs, based on either an EPG or time/channel. At the allotted time (block 700), the event can be recorded with the data being transferred (block 720) to portable device 110 for storage (block 730) as it is created, with accessory 100 acting as a buffer by storing a limited portion of the content (such as a few minutes) before transferring it to the portable device.

Should the portable device not be available (block 710) for the transfer of the data at the allotted time (e.g., if it is powered off, or the app does not have control), then the entire recording can be made using the storage built into accessory 100 (block 740). The recording can be automatically transferred (block 760) for storage in portable device 110 (block 770) the next time that portable device 110 is connected to accessory 100 (block 750).

Should the portable device become unavailable during the recording (block 710), the remaining data can be stored in accessory 100 (block 740) until the next time portable device 110 connects (block 750), at which time the remaining data can be automatically transferred (block 760). The recorded event can be shown on portable device 110 as pending or “connect to complete” for example.

Regarding improvements in datacasting content, the present disclosure provides EPG, content and real time datacasting improvements.

Regarding EPG improvements, the state of EPG in ATSC markets is that only a limited amount of information is guaranteed to be delivered. In other markets (such as Freeview in the UK) the service is more integrated and offers a full 7 day 24 hour EPG. Additionally, information on all the available channels is carried in each channel multiplex. Due to the way TV has developed within ATSC markets, this level of integration is not available.

In order to provide a fully featured service using ATSC, additional EPG information can be provided to allow users to plan their viewing and also schedule recordings, etc.

The present disclosure uses datacasting to provide the additional EPG information. For example:
A single datacasting frequency can provide all EPG information for the channels in the area.
The app can decide which channels can be received and ignore the rest.
The EPG information can be sent in full.
The EPG information can be sent in segments (such as days at a time, 4 hour blocks, etc.). These segments are configured to uses gaps in the datacast schedule and also to provide optimum usability.
The EPG information can be datacast within the datacast of video content (for example, a video on demand event is datacast, and within that datacast some EPG information can be hidden for later use).
The EPG information within the app can be synchronized with the limited broadcast ATSC EPG, in order to ensure that the correct event is recorded, and any over/under-runs in program times are accounted for.
The schedule for datacast content shall itself can be datacast.
The app can re-schedule the recording of datacast content should the initial attempt fail for any reason.
The EPG can contain additional information relating to program/event links to allow the user to select the recording of linked events.
The EPG can contain recommendations for future events.

Regarding content improvements, the state of content delivery is to use either a one size suits all style of approach (e.g., broadcasting), or a unique event driven by that user/device (e.g., Internet/cloud/over-the-top). The present disclosure provides a way to combine the two.

For example, multiple copies of the same event can be datacast at the same time, using the same frequency and bandwidth. The receiving device can decide which copy is best suited for it, and ignore the additional copies.

Additionally, this system can be used to datacast content with different content protection or Digital Rights Management (DRM) technology. This can be important as different portable devices can support different DRM solutions. The system can decide which content is best suited and also which content it has the ability to play back.

As this is datacast, all devices can receive all the copies, with no additional bandwidth or transmission costs involved.

Regarding real time datacasting improvements, datacasting has been designed to offer non-real time delivery of content using available bandwidth. At times this bandwidth exceeds the playback bitrate of the content, so the data is transferred faster than real time. The remaining times the transfer is slower than real time. For the end user, this may not be a problem because the datacast content is not visible to them until the transfer is complete, however long that takes.

The present disclosure uses a fixed bandwidth to transmit real time a new channel. Some key differences are:
This channel can be targeted at portable devices only.
It can be invisible to normal set-top boxes, or via cable/satellite.
The channel can be used to broadcast local news (for example) on a 24 hour basis, with the last broadcast repeated until the next one is available. This can allow users to dip in and out of the service at their convenience, and also allow for use in emergency situations, where real time information availability is required.

FIGS. 8-14 illustrate examples of bandwidth use for accessory 100, with the bandwidth consumed in the vertical axis and time in the horizontal axis.

In the embodiment illustrated in FIG. 8, the overall “standard” ATSC broadcast is shown with a single HD channel, a single SD channel, and the remaining bandwidth being used for datacasting. There can be variants of this, such as multiple SD channels, but no HD channel, or a single HD channel and no SD channel, or a single HD and two SD channels (where the remaining bandwidth is very small). In FIGS. 9-14, only the bandwidth available for datacasting is shown.

In the embodiment illustrated in FIG. 9, a base datacasting figure is shown, where events are sent one after the other based on a transmission schedule, using all the available bandwidth. This is the fastest way to transfer content.

In the embodiment illustrated in FIG. 10, the basic transmission of FIG. 9 is shown with an added EPG transmission. In this embodiment the EPG is transmitted as a completed block at the end of each event.

In the embodiment illustrated in FIG. 11, the embodiment of FIG. 10 is shown with the addition of a constant bandwidth transmission of EPG data. This EPG data is sent at the same time as the main Datacast transmission, with the accessory able to detect this and use the EPG information as it requires.

This is advantageous because a full 7-day 24 hour EPG for all channels is a large file, but sending small updates to the EPG (based around sending just a single 24 hour of information for example), and sending these more regularly means that the portable device can pick up on them easier, without having to wait for a datacast event to finish. Sending smaller updates in parallel with the datacast event allows the portable device to get a smaller set of data, but the most important data, more quickly.

In the embodiment illustrated in FIG. 12, two simultaneous datacast “channels” or streams are shown. Each stream contains different content broadcast to its own individual schedule.

In the embodiment illustrated in FIG. 13, two simultaneous datacast streams are shown similar to FIG. 12. However, in this embodiment the event being datacast is the same on both, with a time delay on the second channel. The second stream can be a time shifted mirror of the first stream, and in different embodiments the content within each stream does not need to be the same “Event 1.”

Because the datacast content is transmitted on a schedule, having time-shifted datacasts allows the user to get content that they may have missed. For example, presume the user is provided with a list of films, they choose Die Hard. The last Datacast of Die Hard may have started 10 minutes ago, and the next one is in a few days, resulting in a poor user experience. By time shifting Die Hard to be sent again one hour later, for example, then the user experience can be improved.

In the embodiment illustrated in FIG. 14, some of the bandwidth is used for a constant datacast stream of “live” content. This content does not need to be an actual live broadcast, but it can be viewed in real time equivalent to a broadcast channel specifically for portable devices. Should the data being transmitted be sent at the bit rate used for playback then the datacast is effectively real time (live). So, for example, the target bit rate for HD quality content on a tablet may be around 2 Mb/s. If a signal is datacast using a bit rate of 2 Mb/s and the content contained within the datacast is also at 2 Mb/s, then the portable device can play the content as it arrives, with no buffering, etc.

Of course the transmission of EPG as shown in FIGS. 10 and 11 can be also used with any of FIGS. 12-14.

The following provides a general use case and six specific use cases (watching TV, personal video recorder (PVR) recording, watching recorded content, datacasting, and autorecording) for a T-Pod.

Regarding the general use case, if the portable device is not connected to a T-Pod (e.g., either no network connection, offline, or no T-Pod detected) then a list of available content on the portable device can be provided. The content can be played back in landscape mode by default, on a quarter screen, with the ability to be shown full screen. Portrait mode can be supported. When the content is not full screen, the remaining space can be used by EPG information, program information, status indications and social networking, for example.

Regarding the watching TV use case, when using the app the user can select which channel or program to watch, and the device can display live TV. Should the user select to pause the TV, then the ability to pause can be determined by the media player used on the portable device and the size of its buffer. Should the buffer be full, or live pause not supported, the user can revert to live once the user releases the pause. It may not be possible for the user to rewind content during live TV.

Regarding the personal video recorder (PVR) recording use case, when watching ATSC live content, the user can select to record at any time by selecting record. This can be manually started and stopped. Additionally the user can select any program on the user's EPG to record in the future. Recording is carried out by the T-Pod, with the recorded file transferred to the portable device as soon as it is connected. For example, if the portable device is available during the recording, then the file can be transferred as recording is taking place. Should the portable device be unavailable (e.g., off-line or the app not running) then the recording can still be made, and transferred to the portable device as soon as possible.

When recording (either by the use of manual recording or scheduled via the PVR) the available capacity within the portable device should be shown, such as in minutes. In cases where the portable device is not connected, and the T-Pod has an Internet connection then the T-Pod can send a notification to the portable device, using the apple notification center in embodiments using Apple portable devices such as the IPHONE or IPAD when recording is complete to let the user know it is ready to collect. Should a recording fail for any reason (for example, battery low within the T-Pod) then the user can receive a notification when they next start the app.

Regarding the watching recorded content use case, the user can be presented with a list of available content, both ATSC recorded content and also any content they have selected from the datacast options (or anything pushed to their device). They can then choose to watch or delete the content at their convenience. There can also be a display indicating the amount of free space for recordings on the device.

Regarding the datacasting use case, if there is content being datacast at 1×, then this can be displayed as an additional channel on the EPG. As for any channel, the content can be recorded or watched “live.” For content being datacast at higher speeds, this can be displayed also as an EPG showing them certain content is available for download.

As for ATSC recording, the datacast content can be first stored within the T-Pod and transferred to the portable device when connection is available. If the portable device is connected when the datacast is taking place, the user can start to watch the content immediately, but fast forward options may be limited until the relevant part of the file has been downloaded. In all cases (except for 1× datacasting) the datacast content can be transferred onto the portable device.

As for ATSC recording, if the T-Pod is connected to the Internet, the portable device can be sent a notification when the datacast recording is complete. Optionally, the datacast content can be displayed as a list (e.g., with cover art). If the Datacast fails to record as was scheduled, then it can automatically be rescheduled for the next available Datacast, and the user prompted.

Regarding the autorecording use case, as for PVR and datacasting, autorecording of content can initially take place within the T-Pod. If the user's portable device is available at that time, then the content can be pushed directly to the portable device. If this is not the case, then the next time the device is available, the content can be pushed to the portable device. Should the T-Pod be moved out of signal range, then the user can be presented with an error message (directly on the portable device if possible, or sent via the OS messaging system). For live content, should the signal quality drop, the user can be prompted once it reaches a critical point.

Autorecording can record broadcast channels/programs based upon broadcaster recommendations, or also this function can enable “series link.” The autorecorded content can be displayed as additional recorded items, or could also be displayed as a virtual channel on the EPG.

The following provides seven functional groups that can be provided in a specification of the app. These include EPG display, signal strength indicator, scheduling, recorded content display, playback of content, download of content from connected T-Pod, social network interaction and audience measurement.

Regarding EPG display, the app can display a 7 day EPG of live content. In cases where the T-Pod is connected to the Internet, this can be downloaded. This can require that the app either knows its current location or can provide a list of detected ATSC channels and signal strengths to allow determination of the location.

It is also possible to Datacast the EPG. Should the full EPG not be available (e.g., no Internet or datacast), then the EPG display can show now/next as this is the only information that may be reliably obtained from off air broadcast.

The EPG can allow easy selection of items for extended information, and also scheduling recordings, etc. The EPG can have either a separate component for datacast content, or this can be displayed as an additional channel.

Regarding signal strength indicator, there can be a signal strength indicator showing the quality of signal on the given channel. This allows positioning of the T-Pod for optimum performance. The signal strength indicator can be displayed again if the quality of signal drops.

Also an additional indicator can be the battery state of the T-Pod. If the T-Pod is operating under battery power, an approximate lifetime or percentage life left can be shown.

Regarding scheduling, this can be done via the main EPG display, with the option to schedule/delete a scheduled recording as required. There can also be a short cut to allow display of all the scheduled events currently within the app.

For any scheduled recording, an indication of the space required within the device can be given.

Regarding recorded content display, a full list of recorded content can be provided. This can allow the user to easily navigate and manage the user's recordings. There can be an indication within this display showing the available and used space within the device for recordings.

The datacast content can be displayed in a similar list fashion, or using cover art which is also datacast.

Regarding playback of content, the content, be it live or recorded, can be displayed either as full screen, or as a window (e.g., quarter screen). When not full screen, half of the screen can be used for social network interaction (see below).

Regarding download of content from connected T-Pod, the app can be able to download recorded, autorecorded and datacast content from the T-Pod, and decide what to do with them. The datacast can contain both AV content, as well as additional content (such as EPG, cover art, pre-roll adverts, etc.).

Regarding social network interaction, as a minimum this can allow the user to log into the user's social network account(s), such as FACEBOOK and/or TWITTER, and view the user's timeline, easily search on specific tags (such as program name, station name, actors, etc.) and post comments.

Regarding audience measurement, the app can maintain a log of the activity of the app, relating to content. All channels watched and the duration can be logged, along with any viewing related to recorded content. When the tablet is connected to the Internet, this log can be provided to a central server for processing.

The following relates to the headend specification. The headend (e.g., broadcast network 300) can be based on existing technology/developments from MOTIVE TELEVISION PLC. The headend can encapsulate datacast content, as well as autorecord commands, with a MPEG2 TS stream. The headend can interface directly into the ATSC broadcast infrastructure. Thus, datacasting and autorecord functions can provided by servers (e.g., MOTIVE servers) at the broadcasters' headend.

The use cases for broadcasters in the present disclosure can be the direct access to the portable device, and the targeting of content for that portable device. Also the sale/lease of part of the broadcasters' spectrum to a third party to provide datacast content services. This can be done on a country wide basis, so for example once a series of broadcasters had signed up to provide their spectrum at a certain cost, a third party could provide a country wide video service, offering the same content everywhere.

If no accompanying technology, such as MOTIVE tech, is used by any broadcaster that can be received by the T-pod, the user can still access live TV and the ability to record. The user can also playback any previously datacast content if it has been already stored.

Further, if a portable device has a built-in TV tuner(s), the app can provide much of the functionality described above using the built-in tuner(s) without the T-Pod. In particular, datacasting can be supported using a portable device with a built-in tuner. At this time, a transcoder is typically not included within portable devices, which means that recording of content may not be viable due to the potentially large file sizes created for HD recordings. The app can allow for datacast content to be selected/stored within the portable device, but this can be subject to risks as the user would need to have the portable device on and in a good signal location during the datacast. Also, if the portable device has only a single tuner built-in, then the user may only be able to watch live content that is being broadcast on that particular frequency during the datacast reception. For example, if the KOFY signal is used in San Francisco, on the same frequency one will find the HD KOFY signal and a SD MeTV signal).

Thus, advantages of the present disclosure include:
Datacasting EPG information. Due to the limited amount of information mandated by ATSC standards, a full EPG (7 day 24 hr) cannot be received via broadcast only today. State of the art relies on either a full cable/satellite system to provide this information or Internet based providers. Providing this information via datacasting gives the user the ability to use a full featured broadcast only system, with no Internet access required.
Datacasting VoD content for portable devices. Due to the nature of content for portable devices, it requires less bandwidth or size (reduced screen size, frame rate, bit rate, improved audio/video codecs, etc.). Content can be pre-prepared and scheduled for datacasting, with the schedule made available to the end user. The user can then choose to receive specific datacast content, and a recording will be scheduled.
Datacasting multiple copies of the same content, targeted at different devices, potentially using different DRM solutions.
Datacasting “live” channel. Due to the reduced bit rate required, it is possible to transmit an as-live broadcast channel specifically for portable devices. As this channel requires no Internet access, quality can be guaranteed.
Datacasting EPG content at the same time as other content. Interleaving small amounts of EPG data with the larger content datacast allows the portable device to update its EPG whenever it is receiving datacast information (when the tuner is on the specific channel).
Supplementing Datacast EPG content with limited broadcast EPG content. The merging of the datacast information with the current channel's broadcast EPG, to account for any program changes, over-runs etc.
Supplementing Datacast EPG content, and broadcast EPG content with Internet sources where available. Using Datacast as the primary source of EPG, with broadcast used for current event verification. A back-up position is to download any missing parts of the EPG from the Internet as required.
Automatic re-scheduling of recording/datacast/auto-recording if portable device is not available/capacity is not available. Due to the nature of portable devices, at the scheduled time of recording, it might not be available to record the channel/datacast, etc. As a result, an automatic re-scheduling service can be used, where any repeat of the same content can be scheduled for recording, and the user prompted when they next use the service.
Using the built-in location information from the smart device to determine which stations should be received in a given location, and further which stations have the highest power.
Setting the accessory device to the strongest of these stations, then measuring the actual signal strength, and providing a visual feedback to the user. This visual feedback provides a real time indication to the customer, allowing them to move the accessory device to improved signal reception.
Only the stations listed as being able to be received in the users location can be tuned, improving the set-up time and user experience.
Optionally, the user can be presented with a list of the stations which are just out of range, or which are slightly too weak at the current antenna position, and they have the option to try and optimize for receiving these stations.
Should the station with the highest power, which is used above, have a strong signal without moving the antenna, then all stations available can be tuned without any further user intervention.
A signal strength/quality indication can be provided when playing back any station, so that if the user moves location they can re-optimize the signal.
On the channel list presented to the user, the high power/quality stations can be shown with an indicator showing that these are suitable for recording, etc. Lower power/quality stations can be given a secondary indication, which indicates to the user that recordings might fail with the antenna at its current location.
When recording content for later playback on the portable device, it can first be stored within the accessory device. If the portable device is not available (due to being powered off, or the app not running, e.g.) then the accessory device can store the complete recording. Otherwise, it acts as a buffer, storing a few minutes of content before transferring to the portable device.

FIG. 15 illustrates an example of a computing device, which may generally correspond to portable device 110, portable device 112 and other computing devices configured to function in a similar capacity. The form of computing device 1500 may be widely varied. For example, computing device 1500 can be a personal computer, workstation, server computing device, portable computing device, or any other suitable type of microprocessor-based device. Computing device 1500 can include, for example, one or more components including processor 1510, input device 1520, output device 1530, storage 1540, and communication device 1560. These components may be widely varied, and can be connected to each other in any suitable manner, such as via a physical bus, network line or wirelessly for example.

For example, input device 1520 may include a keyboard, mouse, touch screen or monitor, voice-recognition device, or any other suitable device that provides input. Output device 1530 may include, for example, a monitor, printer, disk drive, speakers, or any other suitable device that provides output.

Storage 1540 may include volatile and/or nonvolatile data storage, such as one or more electrical, magnetic or optical memories such as a RAM, cache, hard drive, CD-ROM drive, tape drive or removable storage disk for example. Communication device 1560 may include, for example, a network interface card, modem or any other suitable device capable of transmitting and receiving signals over a network.

The network may include any suitable interconnected communication system, such as a local area network (LAN) like WiFi or a wide area network (WAN) for example. The network may implement any suitable communications protocol and may be secured by any suitable security protocol. Corresponding network links may include, for example, telephone lines, DSL, cable networks, T1 or T3 lines, wireless network connections, or any other suitable arrangement that implements the transmission and reception of network signals. The network may include, for example, the WiFi hotspot provided by accessory 100 and home network 420 described above.

Software 1550 can be stored in storage 1540 and executed by processor 1510, and may include, for example, programming that embodies the functionality described in the various embodiments of the present disclosure. The programming may take any suitable form. Software 1550 may include, for example, the app provided on accessory 100 described above.

Software 1550 can also be stored and/or transported within any computer-readable storage medium for use by or in connection with an instruction execution system, apparatus, or device, such as computing device 1500 for example, that can fetch instructions associated with the software from the instruction execution system, apparatus, or device and execute the instructions. In the context of this document, a computer-readable storage medium can be any medium, such as storage 1540 for example, that can contain or store programming for use by or in connection with an instruction execution system, apparatus, or device.

Software 1550 can also be propagated within any transport medium for use by or in connection with an instruction execution system, apparatus, or device, such as computing device 1500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An accessory for a portable device comprising:
an antenna interface;
a tuner configured to receive broadcast television signals via the antenna interface;
a processor configured to transfer content from the received broadcast television signals to the portable device; and
a battery configured to power the accessory.

2. The accessory of claim 1, comprising an antenna connected to the antenna interface.

3. The accessory of claim 1, wherein the antenna interface is connectable to an external antenna.

4. The accessory of claim 1, wherein the accessory lacks a screen.

5. The accessory of claim 1, comprising a storage and wherein the processor is configured to
store content from the received broadcast television signals in the storage in response to the portable device being unavailable, and
transfer content to the portable device in response to the portable device being available.

6. The accessory of claim 5, wherein the processor is configured to transfer the content to the portable device by buffering a limited portion of the content at a time in the storage.

7. A computing device comprising:
a processor configured to
determine a location of the computing device,
obtain a list of broadcast television stations associated with the determined location, and
present which of the listed broadcast television stations are available to a tuner associated with the computing device.

8. The computing device of claim 7, wherein the processor is configured to receive from the tuner which of the listed broadcast television stations are available to the tuner.

9. The computing device of claim 7, wherein the processor is configured to receive an indicator of signal strength associated with one or more of the listed broadcast television stations.

10. The computing device of claim 7, wherein the tuner is external to the computing device.

11. The computing device of claim 10, wherein the processor is configured to receive an indicator of battery life remaining for an accessory comprising the tuner.

12. The computing device of claim 7, wherein the tuner is internal to the computing device.

13. A method comprising:
scheduling, by a processor, multiple copies of the same content for datacasting; and
datacasting, by a processor, the scheduled content concurrently via broadcast television signals.

14. The method of claim 13, wherein the scheduled content is datacast using the same frequency and bandwidth.

15. The method of claim 13, wherein each of the multiple copies is targeted at a distinct computing device.

16. The method of claim 13, wherein each of the multiple copies uses distinct digital rights management.

17. A method comprising:
scheduling, by a processor, program guide data and content for datacasting; and
datacasting, by a processor, the scheduled program guide data and content concurrently via broadcast television signals.

18. The method of claim 17, wherein the scheduled program guide data and content is datacast using the same frequency and bandwidth.

19. The method of claim 17, wherein the scheduled program guide data is distinct from program guide data datacast in a different channel via broadcast television signals.

20. A method comprising:
scheduling, by a computing device, content to be datacast in a live channel; and
datacasting, by a computing device, the scheduled content via broadcast television signals.
